(19) United States
(12) Patent Application Publication
(10) Pub. No.: US 2025/0102984 A1
(43) Pub. Date: Mar. 27, 2025

(54) IMAGE FORMING APPARATUS, PROCESSING SYSTEM, NON-TRANSITORY COMPUTER READABLE MEDIUM, AND METHOD

(71) Applicant: FUJIFILM Business Innovation Corp., Tokyo (JP)

(72) Inventor: Masaru YOKOTA, Kanagawa (JP)

(73) Assignee: FUJIFILM Business Innovation Corp., Tokyo (JP)

(21) Appl. No.: 18/590,584

(22) Filed: Feb. 28, 2024

(30) Foreign Application Priority Data
Sep. 27, 2023 (JP) 2023-164161

(51) Int. Cl. G03G 15/00

(52) U.S. Cl. CPC G03G 15/55; G03G 15/5016; G03G 15/757

(57) ABSTRACT

An image forming apparatus includes an image forming unit that transfers a toner image onto a recording medium, the toner image being formed on an image carrier by an electrophotographic system; and one or more processors that control an operation of the image forming unit, and that are configured to: when causing the image forming unit to perform multiple operations under different conditions of charging and exposure to light, cause the image forming unit to perform later an operation with charging and exposure to light, the operations including at least the operation with charging and exposure to light and an operation without charging nor exposure to light, the operation with charging and exposure to light being an operation in which a toner image is formed with the image carrier having been subjected to charging and exposure to light, the operation without charging nor exposure to light being an operation in which a toner image is formed with the image carrier having been subjected to neither charging nor exposure to light.

### CROSS-REFERENCE TO RELATED APPLICATIONS

This application is based on and claims priority under 35 USC 119 from Japanese Patent Application No. 2023-164161 filed Sep. 27, 2023.

### BACKGROUND

### (i) Technical Field

The present disclosure relates to an image forming apparatus, a processing system, a non-transitory computer readable medium, and a method.

### (ii) Related Art

An image forming apparatus using an electrophotographic system has a function of forming a toner image with a photoreceptor drum which has not been subjected to charging nor exposure to light, and checks for a malfunction of the apparatus by using images formed under various conditions of charging and exposure to light.

Japanese Unexamined Patent Application Publication No. 7-68842 discloses a technique of identifying the cause of occurrence of exposure unevenness in an exposure sequence. In the technique, an exposure system uniformly exposes the entire surface of a photoreceptor to light to form a toner image on the drum. Then, the toner image is transferred onto a transfer sheet and is fixed to generate a test sample S1. Similarly, pre-exposure and first charging are performed; light exposure is blocked by the exposure system; a test sample S2 is thus generated. The cause of occurrence of exposure unevenness in the exposure sequence is identified from the determination result about whether exposure unevenness occurs in the sample S1 obtained with the entire, uniform exposure and exposure unevenness disappears in the sample S2 obtained with the exposure blocked.

When a toner image is formed with a photoreceptor drum which has not been subjected to charging nor exposure to light, in-device contamination and bead-carry-out (BCO) may occur. In-device contamination refers to toner particles resident at a place where toner particles inside a developing device are not to be supplied. BCO refers to the state in which carrier beads contained in a developer move onto a photoreceptor.

### SUMMARY

Aspects of non-limiting embodiments of the present disclosure relate to a technique of suppressing occurrence of in-device contamination and BCO in the case where images are formed under various conditions of charging and exposure to light, compared with the configuration in which the last toner image is formed without charging nor exposure to light.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus comprising: an image forming unit that transfers a toner image onto a recording medium, the toner image being formed on an image carrier by an electrophotographic system; and one or more processors that control an operation of the image forming unit, and that are configured to: when causing the image forming unit to perform a plurality of operations under different conditions of charging and exposure to light, cause the image forming unit to perform later an operation with charging and exposure to light, the plurality of operations including at least the operation with charging and exposure to light and an operation without charging nor exposure to light, the operation with charging and exposure to light being an operation in which a toner image is formed with the image carrier having been subjected to charging and exposure to light, the operation without charging nor exposure to light being an operation in which a toner image is formed with the image carrier having been subjected to neither charging nor exposure to light.

### BRIEF DESCRIPTION OF THE DRAWINGS

Exemplary embodiment of the present disclosure will be described in detail based on the following figures, wherein:

FIG. 1 is a diagram illustrating the configuration of a processing system to which the present exemplary embodiment is applied;

FIG. 2 is a diagram illustrating an image forming apparatus according to the present exemplary embodiment;

FIG. 3 is a diagram for describing an exemplary image forming unit;

FIG. 4 is a diagram illustrating an exemplary hardware configuration of a control device;

FIG. 5 is a diagram illustrating the following states of an image forming unit in diagnostic mode: in column (A), the state of the image forming unit under a first image forming condition; in column (B), the state of the image forming unit under a second image forming condition; in column (C), the state of the image forming unit under a third image forming condition; in column (D), the state of the image forming unit under a fourth image forming condition; and, in column (E), the state of the image forming unit under a fifth image forming condition;

FIG. 6 is a diagram illustrating the output order of sheets;

FIG. 7 is a diagram illustrating the order in which sheets are to be viewed;

FIG. 8 is a diagram illustrating an exemplary configuration of an information processing apparatus;

FIG. 9 is a diagram illustrating an exemplary evaluation input screen;

FIG. 10 is a diagram illustrating an exemplary diagnostic result screen;

FIG. 11 is a diagram illustrating an example in which an image forming apparatus is diagnosed; and

FIG. 12 is a diagram illustrating an exemplary diagnostic result of an image forming apparatus.

### DETAILED DESCRIPTION

An exemplary embodiment of the present disclosure will be described below by referring to the attached drawings.

### The Configuration of a Processing System

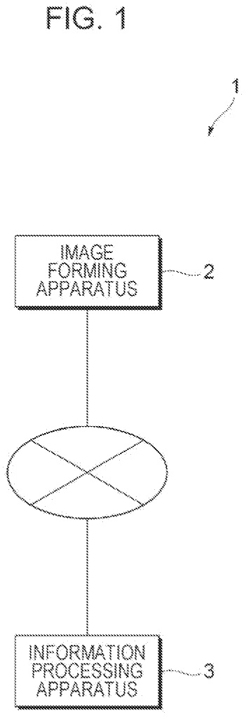

FIG. 1 is a diagram illustrating the configuration of a processing system 1 to which the present exemplary embodiment is applied. The processing system 1 includes an image forming apparatus 2 and an information processing apparatus 3. The apparatuses 2 and 3 are connected to each other over a network. The network, which is a communication unit used in information communication between the image forming apparatus 2 and the information processing apparatus 3, is, for example, a local area network (LAN). The image forming apparatus 2 and the information processing apparatus 3 may be connected by using the Internet or public lines, or may be directly connected by using a communication cable.

The image forming apparatus 2 reads documents and forms images on sheets P, which are an exemplary recording medium, through user operations. The information processing apparatus 3 reads sheets P, on which images have been formed, and determines the state of the image forming apparatus 2. The information processing apparatus 3 will be described below.

### The Configuration of the Image Forming Apparatus

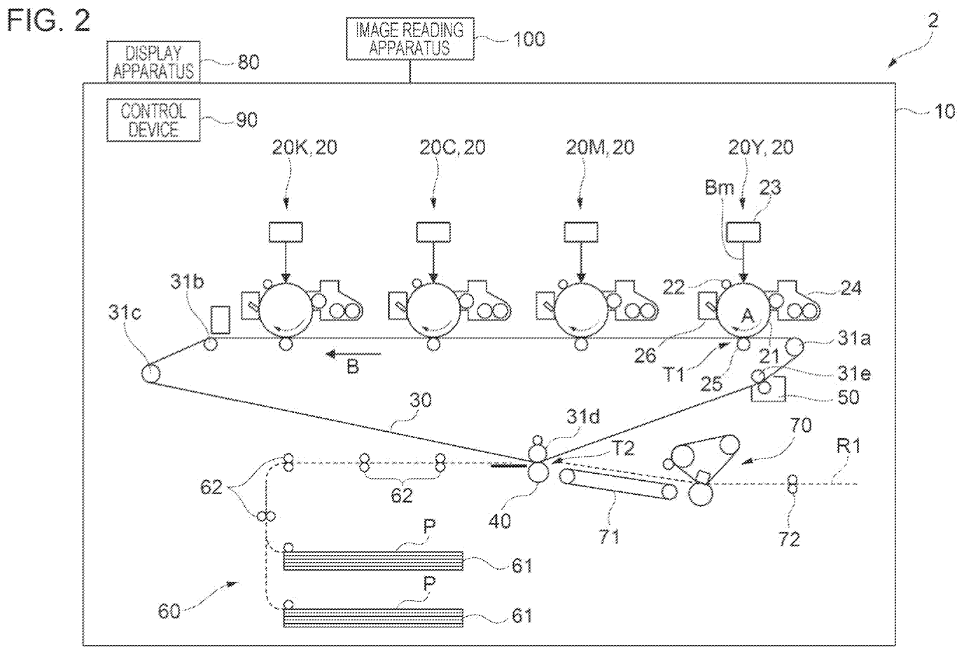

FIG. 2 is a diagram illustrating the image forming apparatus 2 according to the present exemplary embodiment.

As illustrated in FIG. 2, the image forming apparatus 2 has a housing 10. The image forming apparatus 2 has, in the housing 10, image forming units 20, an intermediate transfer belt 30, a second transfer roller 40, a belt cleaner 50, a paper feed unit 60, a fixing device 70, a display apparatus 80, and a control device 90. The image forming apparatus 2 includes a communication interface (not illustrated) used in information communication. An image reading apparatus 100, which reads images of documents which are put on its document platen, is disposed on the top surface of the housing 10. The dashed line illustrated in FIG. 2 indicates a transport path (R1) of sheets P. In the present exemplary embodiment, the image forming apparatus 2 employs an electrophotographic system.

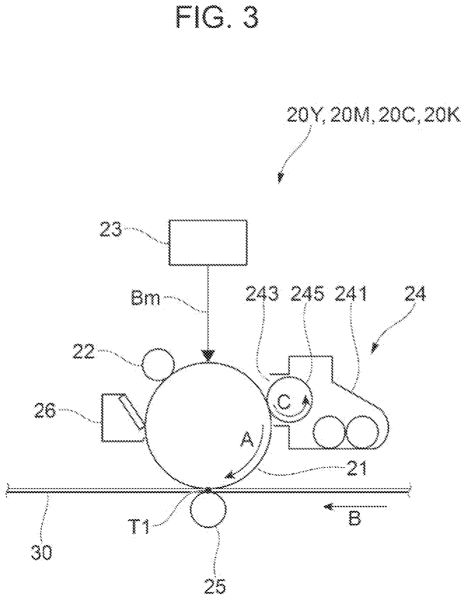

FIG. 3 is a diagram for describing an exemplary image forming unit 20.

The image forming units 20 are constituted, for example, by four image forming units 20Y, 20M, 20C, and 20K which individually form toner images of the respective four colors of yellow (Y), magenta (M), cyan (C), and black (K). By using FIG. 3, the image forming units 20 will be described using one of the image forming units 20Y, 20M, 20C, and 20K.

The image forming unit 20 includes a photoreceptor drum 21. The photoreceptor drum 21 receives power from a driving device (not illustrated). While the photoreceptor drum 21 rotates in the arrow A direction, an electrostatic latent image is formed. A charging device 22, an exposure device 23, a developing device 24, a first transfer roller 25, and a drum cleaner 26 are disposed around the photoreceptor drum 21. The charging device 22 charges the surface of the photoreceptor drum 21 to a predetermined potential.

For example, the exposure device 23 exposes the photoreceptor drum 21 to laser light to form an electrostatic latent image on the surface of the photoreceptor drum 21. In FIG. 3, light emitted from the exposure device 23 is denoted by reference character Bm. The potential at positions, where exposure to light is performed, of the photoreceptor drum 21, which has been charged by the charging device 22, is decreased. The exposure device 23's exposure of the photoreceptor drum 21 to light is not limited to exposure using laser light. For example, a light source such as a light emitting diode (LED) may be provided for each image forming unit 20, and the photoreceptor drum 21 may be exposed to light emitted from the light source.

The developing device 24 makes an electrostatic latent image, which has been formed on the photoreceptor drum 21, visible by using a developer. The developing device 24 includes a container 241 which contains a developer. For example, the container 241 is formed by a resin container housing. The developing device 24 is disposed so as to extend in the direction from the front to the rear of the image forming apparatus 2 (the direction orthogonal to the plane of FIG. 3).

The container 241 has an opening 243 disposed so as to be opposite the photoreceptor drum 21 (see FIG. 3). In the opening 243, a developing roller 245 for depositing toner on the surface of the photoreceptor drum 21 is disposed. The developing roller 245, which is columnar, is disposed so as to extend in the direction from the front to the rear of the image forming apparatus 2 (the direction orthogonal to the plane of FIG. 3). The developing roller 245 receives power from a driving device (not illustrated). While rotating in the arrow C direction illustrated in FIG. 3, the developing roller 245 deposits toner on the surface of the photoreceptor drum 21.

The developer according to the present exemplary embodiment includes dry carrier powder and dry toner powder. Each of the image forming units 20Y, 20M, 20C, and 20K uses the dry carrier powder and the dry toner powder to form a toner image on the photoreceptor drum 21. In this example, the carrier has the positive charge polarity; the toner has the negative charge polarity.

The first transfer roller 25 electrostatically transfers a toner image, which has been formed on the photoreceptor drum 21, onto the image-carrying surface of the intermediate transfer belt 30 at a first transfer position T1. At the first transfer position T1, a potential difference (first transfer bias) is caused to occur between the photoreceptor drum 21 and the first transfer roller 25. Thus, a toner image on the photoreceptor drum 21 is transferred onto the intermediate transfer belt 30 nipped between the photoreceptor drum 21 and the first transfer roller 25. The drum cleaner 26 is a cleaning member which removes residual toner on the surface of the photoreceptor drum 21 after first transfer.

The intermediate transfer belt 30 transports the toner image, which has been transferred onto the image-carrying surface of the intermediate transfer belt 30, to a second transfer position T2. As illustrated in FIG. 2, the intermediate transfer belt 30 is disposed at a position below the image forming units 20Y, 20M, 20C, and 20K. The intermediate transfer belt 30 is disposed so as to be nipped by the photoreceptor drums 21 of the respective image forming units 20Y, 20M, 20C, and 20K and the first transfer rollers 25. As illustrated in FIG. 2, the intermediate transfer belt 30 rotates at a predetermined rate in the arrow B direction through a driving roller 31a, which is driven by a driving device (not illustrated), and supporting rollers 31b to 31e.

The supporting roller 31b holds the first transfer surface in cooperation with the driving roller 31a. The supporting roller 31c provides tension to the intermediate transfer belt 30. The supporting roller 31d is a backup roller which supports transfer performed by the second transfer roller 40. The supporting roller 31e supports cleaning residual toner on the intermediate transfer belt by the belt cleaner 50 after second transfer.

The second transfer roller 40 electrostatically transfers toner images, which are held on the image-carrying surface of the intermediate transfer belt 30, onto a sheet P at the second transfer position T2. As illustrated in FIG. 2, the second transfer roller 40 is disposed so as to be opposite the supporting roller 31d with the intermediate transfer belt 30 interposed in between. At the second transfer position T2, a potential difference (second transfer bias) is caused to occur between the supporting roller 31d and the second transfer roller 40. Thus, toner images are transferred from the intermediate transfer belt 30, which is nipped between the supporting roller 31d and the second transfer roller 40, onto a sheet P. The belt cleaner 50 is a cleaning member which removes, for example, residual toner on the intermediate transfer belt 30 after second transfer.

The paper feed unit 60 includes sheet containers 61 and multiple feed rollers 62. The sheet containers 61 contain various types of sheets P which are to be supplied to the second transfer position T2. The feed rollers 62 feed sheets P, one by one, from a sheet container 61 to the sheet transport path R1, and transport the sheets P to the second transfer position T2. As illustrated in FIG. 2, the paper feed unit 60 is disposed below the intermediate transfer belt 30. The number of sheet containers 61 may be increased or decreased when necessary. A manual-feed tray (not illustrated), which is connected to the sheet transport path R1, may be disposed outside the housing 10.

The fixing device 70 fixes toner images which have been subjected to second transfer to a sheet P. As illustrated in FIG. 2, the fixing device 70 is disposed below the intermediate transfer belt 30. The fixing device 70 includes a heating roller and a pressure roller. As illustrated in FIG. 2, at the position where the heating roller is in contact with the pressure roller, a fixing process using heating and pressurization is performed on a sheet P.

The sheet transport path R1, which is a path along which a sheet P is transported, is disposed so as to connect the paper feed unit 60 to a sheet discharge tray (not illustrated). The sheet transport path R1 is illustrated by using a dashed line in FIG. 2. As illustrated in FIG. 2, on the sheet transport path R1, the feed rollers 62, a transport roller 71, and discharge rollers 72 are disposed. As described above, the feed rollers 62 feed a sheet P from a sheet container 61 to the sheet transport path R1, and transport the sheet P to the second transfer position T2. The transport roller 71 transports a sheet P, onto which toner images have been transferred at the second transfer position, to the fixing device 70. The discharge rollers 72 transport a sheet P, on which toner images have been fixed, to the sheet discharge tray (not illustrated).

The display apparatus 80 is, for example, a display disposed on the outer surface of the housing. The display apparatus 80 receives instructions from users, and displays information to users. The display apparatus 80, which is formed, for example, of a touch panel and the like, is used as a display apparatus and an operation device.

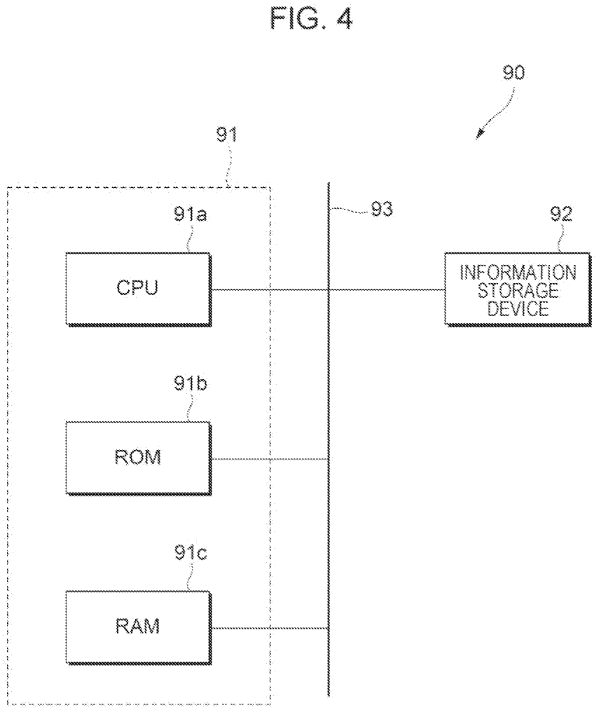

The control device 90, which is disposed inside the housing 10, controls operations of the image forming apparatus 2. For example, the control device 90 controls operations, such as image reading and image formation, and image forming operations in diagnostic mode described below. These operations are performed by a central processing unit (CPU) 91a (see FIG. 4) reading programs, which are stored in an information storage device 92 or the like, onto a random access memory (RAM) 91c, which is used as a work area, for execution. The CPU 91a is an exemplary processor described below.

### The Configuration of the Control Device

FIG. 4 is a diagram illustrating an exemplary hardware configuration of the control device 90.

The control device 90 includes a computation processor 91 and the information storage device 92 which stores information. The computation processor 91 is formed by a computer. The computation processor 91 includes the CPU 91a, which is an exemplary processor performing various processes described below. The computation processor 91 includes a read only memory (ROM) 91b, which stores programs, and the RAM 91c, which is used as a work area. The information storage device 92 is implemented by using an existing device, such as a hard disk drive or a semiconductor memory. The computation processor 91 is connected to the information storage device 92 through a bus 93 or a signal line (not illustrated).

Programs executed by the CPU 91a may be provided to the control device 90 in the state in which the programs are stored in a computer-readable recording medium, such as a magnetic recording medium (for example, a magnetic tape or a magnetic disk), an optical recording medium (for example, an optical disk), a magneto-optical recording medium, or a semiconductor memory. Programs executed by the CPU 91a may be provided to the control device 90 by using a communication unit such as the Internet. The programs provided to the control device 90 are stored in the information storage device 92.

In the present specification, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

### An Image Forming Operation Performed by the Image Forming Apparatus

By using FIGS. 2 and 3, an image forming operation performed by the image forming apparatus 2 will be described. This operation is performed in such a manner that the CPU 91a, which is an exemplary processor, reads programs, which are stored in the ROM 91b or the like, onto the RAM 91c, which is used as a work area, for execution. In this example, the case of forming a full-color image, which is constituted by a combination of toner images of four colors of Y, M, C, and K, will be described as an example. On the other hand, for example, a monochrome image may be formed with only the image forming unit 20 (K) operating.

Upon reception of a request for an image forming operation, which is submitted, for example, through a user operation, the image forming apparatus 2 rotates the photoreceptor drums 21 of the image forming units 20Y, 20M, 20C, and 20K in the arrow A direction. The charging devices 22 charge the surfaces of the photoreceptor drums 21 to the predetermined potential.

Upon reception of image data, which is output from the image reading apparatus 100, a PC, or the like, along with the request for the image forming operation, the image forming apparatus 2 performs image processing on the image data. Thus, pieces of image data corresponding to the respective image forming units 20Y, 20M, 20C, and 20K are generated. The generated pieces of image data are output to the exposure devices 23.

The exposure devices 23 radiate, for example, light, which is emitted from lasers, to the photoreceptor drums 21 in accordance with the input image data. In the present exemplary embodiment, after the charging devices 22 charge the surfaces of the photoreceptor drums 21 to the predetermined potential, the exposure devices 23 expose the surfaces to light. Thus, electrostatic latent images at the predetermined potential are formed on the surfaces of the photoreceptor drums 21.

The developing devices 24 use the developing rollers 245 to deposit toner on the electrostatic latent images formed on the surfaces of the photoreceptor drums 21. Thus, toner images corresponding to four colors of Y, M, C, and K are formed individually on the surfaces of the photoreceptor drums 21.

The intermediate transfer belt 30 rotates in the arrow B direction. Thus, the toner images, which have been formed on the surfaces of the photoreceptor drums 21 of the image forming units 20Y, 20M, 20C, and 20K, are electrostatically transferred sequentially (in the order of Y, M, C, and K) onto the image-carrying surface of the intermediate transfer belt 30 at the first transfer position T1. The drum cleaners 26 clean residual toner on the image-carrying surfaces of the photoreceptor drums 21.

The intermediate transfer belt 30 further rotates in the arrow B direction. Thus, the intermediate transfer belt 30 transports the toner images, which are obtained through the first transfer onto the image-carrying surface of the intermediate transfer belt 30 and are held on the image-carrying surface, to the second transfer position T2. Meanwhile, in the paper feed unit 60, the feed rollers 62 feed a sheet P from a sheet container 61 along the sheet transport path RI to the second transfer position T2. At the second transfer position T2, the toner images, which are held on the image-carrying surface of the intermediate transfer belt 30, are subjected to second transfer onto the sheet P. The belt cleaner 50 cleans residual toner on the image-carrying surface of the intermediate transfer belt 30.

The sheet P, onto which the toner images have been transferred, is transported by the transport roller 71 to the fixing device 70. The fixing device 70 uses its heating roller and its pressure roller to heat and pressurize the sheet P. Thus, the toner images on the sheet P are fixed onto the sheet P. The sheet P is discharged to a discharge tray (not illustrated) by the discharge roller 72. The operation described above is an image forming operation performed when the image forming apparatus 2 according to the present exemplary embodiment performs a normal image forming operation (in the normal case). When a request for an image forming operation on multiple sheets is received, the image forming operation is repeatedly performed on each sheet in substantially the same manner.

In the present exemplary embodiment, diagnosis of a fault may be performed on each of the image forming units 20Y, 20M, 20C, and 20K. More specifically, in the present exemplary embodiment, determination about whether a fault is present and determination about where the fault has occurred may be performed on each of the image forming units 20Y, 20M, 20C, and 20K. In the present exemplary embodiment, in diagnosis of the image forming units 20, for example, an operator first performs operations on the display apparatus 80 or the like, and specifies an image forming unit 20 which is to be a diagnostic target.

In the present exemplary embodiment, any image forming unit 20 of Y, M, C, or K. which is specified by an operator will be diagnosed. Specification of an image forming unit 20, which is to be a diagnostic target, may be made, not by an operator, but by the control device 90 of the image forming apparatus 2 according to predetermined criteria. Alternatively, the control device 90 may specify the image forming units 20Y, 20M, 20C, and 20K one by one, and all the image forming units 20 may be diagnosed. When an image forming unit 20 is diagnosed, the image forming apparatus 2 performs image forming operations under multiple image forming conditions described below one by one, and forms, on sheets P, images for diagnosis (hereinafter referred to as “diagnostic images”) which are obtained under the image forming conditions. In the description about image forming operations for diagnosis, as described above, the case in which a normal image forming operation is performed is called normal mode. The case in which image forming operations for diagnosis are performed is called diagnostic mode. In each mode, the CPU 91a, which is an exemplary processor, reads programs, which are stored in the information storage device 92 or the like, onto the RAM 91c, which is used as a work area, for execution.

### Diagnostic Mode

In diagnostic mode according to the present exemplary embodiment, there are five image forming conditions, that is, first to fifth image forming conditions. In the present exemplary embodiment, image forming operations under the image forming conditions are performed on an image forming unit 20, which is a diagnostic target, in predetermined order, and the obtained diagnostic images are formed on sheets P. In the present exemplary embodiment, diagnosis is performed by using the five image forming conditions. Alternatively, some of the image forming conditions may be specified for use.

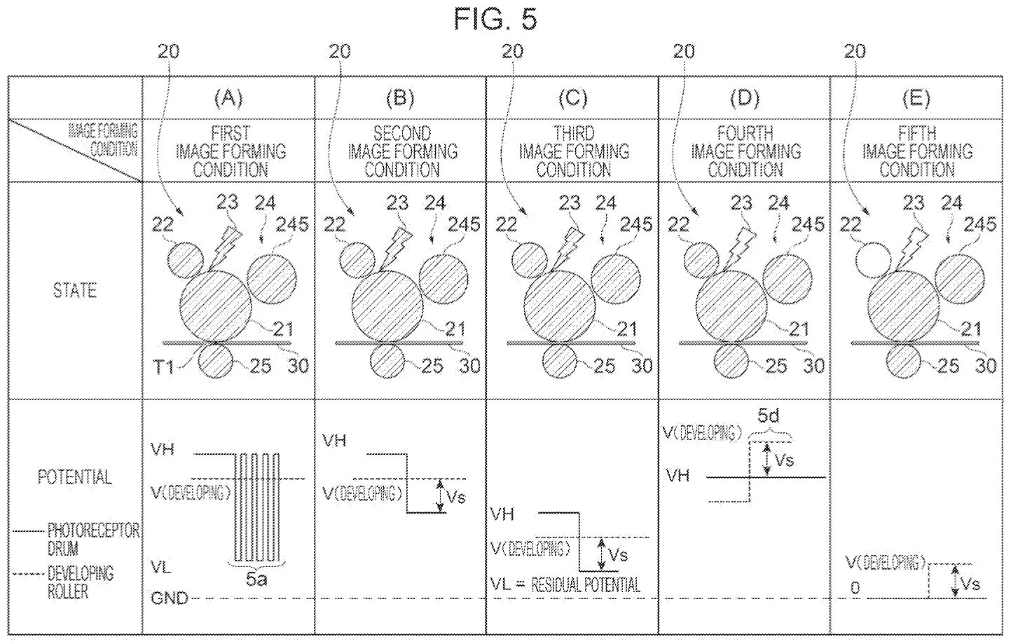

FIG. 5 is a diagram illustrating the states of an image forming unit 20 in diagnostic mode. Column (A) illustrates the state of the image forming unit 20 under the first image forming condition; column (B) illustrates the state of the image forming unit 20 under the second image forming condition; column (C) illustrates the state of the image forming unit 20 under the third image forming condition; column (D) illustrates the state of the image forming unit 20 under the fourth image forming condition; column (E) illustrates the state of the image forming unit 20 under the fifth image forming condition.

In description about potential in FIG. 5, solid lines represent the potential of the photoreceptor drum 21; dashed lines represent the potential of the developing roller 245.

### The First Image Forming Condition

In the case of the first image forming condition illustrated in column (A) of FIG. 5, the image forming unit 20 is in the state which is substantially the same as the normal case. That is, the first image forming condition is the same as the image forming condition in normal mode. In the present exemplary embodiment, in the normal case, as illustrated in column (A) of FIG. 5, the charging device 22 is used to charge the photoreceptor drum 21 so that the potential of the surface of the photoreceptor drum 21 is at VH.

In the normal case, the exposure device 23 is used to radiate light to the surface of the photoreceptor drum 21 selectively. In portions in which an image is to be formed, as illustrated in column (A) of FIG. 5, the potential of the photoreceptor drum 21 is at a potential VL smaller than the potential of the developing roller 245. Thus, toner from the developing roller 245 is deposited on the portions, at the potential VL, of the photoreceptor drum 21, where a toner image is formed. The toner image is transferred onto a sheet P through the intermediate transfer belt 30, and the toner image is formed on the sheet P. Thus, a diagnostic image is formed on a sheet P.

In the normal case, when the density of a formed image is to be decreased, as illustrated by reference character 5a in column (A) of FIG. 5, times in which light is not radiated onto the photoreceptor drum 21 as well as times in which light is radiated onto the photoreceptor drum 21 are provided. Thus, portions without formation of an image are formed. At locations, to which light is radiated, of the photoreceptor drum 21, a dotted toner images are formed; at locations, to which light is not radiated, toner is not deposited and blank areas are formed.

In the present exemplary embodiment, depending on the size of such a dotted toner image and the size of such a blank area, the density of a formed image varies. When such a blank area is relatively larger, a user sees the image as having less density.

### The Second Image Forming Condition

In the case of the second image forming condition illustrated in column (B) of FIG. 5, like the case of the first image forming condition, the photoreceptor drum 21 is charged so that the potential of the surface of the photoreceptor drum 21 is at VH. In addition, in the case of the second image forming condition, the exposure device 23 is used to radiate light onto the photoreceptor drum 21 continuously. That is, in the case of the second image forming condition, the photoreceptor drum 21 is irradiated continuously so that such blank areas as described above are not formed.

In the case of the second image forming condition, a diagnostic image having a low density is formed. Specifically, in the case of the second image forming condition, compared with the normal case illustrated in column (A) of FIG. 5, the output of the exposure device 23 is lowered so that the difference Vs between the potential of the surface of the photoreceptor drum 21 and the potential of the developing roller 245 is small. Thus, in the case of the second image forming condition, a diagnostic image having a low density is formed. In the case of the second image forming condition, to form a diagnostic image having a low density, the amount of exposure itself is decreased instead of forming such blank areas as described above. Thus, a diagnostic image having a low density is formed.

In the case of the second image forming condition, exposure to light is uniformly performed with low exposure output. Tonner from the developing roller 245 is deposited across the entire area, which is uniformly exposed to light and in which a diagnostic image is formed. In the case of the second image forming condition, for example, uneven light emitted from the exposure device 23 causes shading, which is due to the unevenness or the like, to appear more clearly in the formed diagnostic image. In this case, the fact that the image forming unit 20, which is a diagnostic target, has a malfunction may be identified.

As in the normal case, when dotted images and blank areas are formed to decrease the image density, if formed dotted images have unevenness or the like, influence of the unevenness or the like is difficult to appear in a diagnostic image. In contrast, in the case of the second image forming condition illustrated in column (B) of FIG. 5, for example, density unevenness or the like appears more conspicuously in a diagnostic image, and it is clearer that the image forming unit 20 has a malfunction.

### The Third Image Forming Condition

In the case of the third image forming condition illustrated in column (C) of FIG. 5, compared with the case of the second image forming condition, the charge potential VH of the photoreceptor drum 21 and the potential of the developing roller 245 are set to be low. In the case of the third image forming condition, the exposure device 23 is used to radiate light onto the photoreceptor drum 21 continuously. In addition, compared with the case of the second image forming condition, the output of the exposure device 23 is raised.

In the case of the third image forming condition, the charge potential VH of the photoreceptor drum 21 is low, and the output of the exposure device 23 is raised. Thus, exposure to light lowers the potential of the photoreceptor drum 21 to the residual potential of the photoreceptor drum 21. Further, in the case of the third image forming condition, like in the case of the second image forming condition, the surface of the photoreceptor drum 21 is uniformly exposed to light. Toner from the developing roller 245 is deposited across the entire area, which is uniformly exposed to light and in which a diagnostic image is formed.

In the case of the third image forming condition, even if a malfunction occurs in the charging device 22 or the exposure device 23, influence of the malfunction does not affect the potential of the photoreceptor drum 21. In this case, if a malfunction occurs in the charging device 22 or the exposure device 23, influence of the malfunction is difficult to appear in a diagnostic image. In the case of this condition, regardless of whether a malfunction occurs in the charging device 22 or the exposure device 23, the potential of the photoreceptor drum 21 is decreased to the residual potential. Thus, regardless of whether a malfunction occurs in the charging device 22 or the exposure device 23, the potential of the photoreceptor drum 21 stays at a potential having a certain value.

Assume the case in which an image defect, such as density unevenness or a streak, appears in a diagnostic image, which is formed under the second image forming condition of not lowering the potential of the photoreceptor drum 21 to the residual potential. Meanwhile, assume the case in which such an image defect does not appear in a diagnostic image, which is formed under the third image forming condition of lowering the potential of the photoreceptor drum 21 to the residual potential. In this case, it may be detected that the developing device 24 and the first transfer roller 25 do not have any malfunction.

### The Fourth Image Forming Condition

In the case of the fourth image forming condition illustrated in column (D) of FIG. 5, as illustrated by using reference character 5d in column (D) of FIG. 5, the potential of the developing roller 245 is set to be higher than the charge potential VH of the photoreceptor drum 21. In the case of the fourth image forming condition, the photoreceptor drum 21 is not exposed to light. Since exposure to light is not performed, the potential of the photoreceptor drum 21 is not lowered. However, the higher potential of the developing roller 245 causes a developing bias to occur between the photoreceptor drum 21 and the developing roller 245. Therefore, also in this case, toner from the developing roller 245 is deposited on the surface of the photoreceptor drum 21, and a uniform toner image is formed on the surface of the photoreceptor drum 21.

In the case of the fourth image forming condition, since no exposure to light is performed, control related to locations of toner deposition is not exerted. Therefore, toner from the developing roller 245 is deposited across the entire charged surface of the photoreceptor drum 21, where a diagnostic image is formed.

In the case of the fourth image forming condition, it may be detected whether a malfunction occurs in the exposure device 23. Assume the case in which, in the case of the second image forming condition of performing both charging and exposure to light, for example, an image defect of a streak occurs in a diagnostic image, while, in the case of the fourth image forming condition of not performing exposure to light, such an image defect of a streak does not occur. In this case, it may be detected that a malfunction occurs in the exposure device 23.

### The Fifth Image Forming Condition

In the case of the fifth image forming condition illustrated in column (E) of FIG. 5, the potential of the photoreceptor drum 21 is at zero. That is, in the case of the fifth image forming condition, the photoreceptor drum 21 is not charged. In addition, the potential of the developing roller 245 is set to be higher than that of the photoreceptor drum 21. In the case of the fifth image forming condition, the photoreceptor drum 21 is not exposed to light. In the case of the fifth image forming condition, neither charging nor exposure to light is performed. However, the higher potential of the developing roller 245 causes a developing bias to occur between the photoreceptor drum 21 and the developing roller 245. Thus, toner from the developing roller 245 is deposited on the surface of the photoreceptor drum 21. Also in this case, a diagnostic image is formed across the entire surface of the photoreceptor drum 21.

The fifth image forming condition enables a malfunction, which may be present in the charging device 22 or the exposure device 23, to be detected. Assume the case in which, in the case of the second image forming condition of performing both charging and exposure to light, an image defect occurs, and in which, in the case of the fifth image forming condition of performing neither charging nor exposure to light, such an image defect does not occur. In this case, it may be detected that a malfunction occurs in the charging device 22 or the exposure device 23.

The second image forming condition may be a condition for determining whether a malfunction occurs in an image forming unit 20 which is a diagnostic target. A diagnostic image formed under the second image forming condition may be a diagnostic image for determining whether a malfunction occurs in an image forming unit 20 which is a diagnostic target.

The third to fifth image forming conditions are conditions for identifying a component, in which a malfunction has occurred, among multiple components included in an image forming unit 20 which is a diagnostic target. Diagnostic images formed under the third to fifth image forming conditions may be diagnostic images for identifying a component, in which a malfunction has occurred, among the components included in an image forming unit 20 which is a diagnostic target.

### Secondary Fault due to Diagnostic Mode

In the present exemplary embodiment, in execution in diagnostic mode through an operator's operation, the five image forming conditions are used to perform image forming operations on an image forming unit 20 which is a diagnostic target. In the case of a condition different from the normal image forming condition, such as a special image forming condition, for example, of performing neither charging nor exposure to light, a secondary fault may occur. Specifically, examples of the secondary fault include in-device contamination, which indicates the state in which toner particles are accumulated at a place to which toner particles are not to be supplied, and bead-carry-out (BCO), which indicates the state in which carrier beads in the developing device 24 are moved to the photoreceptor drum 21. When such a secondary fault occurs, dot images due to toner particles or carrier beads are formed on an output sheet P.

For example, in the case of the fifth image forming condition, neither charging nor exposure to light is performed. Therefore, as illustrated in column (E) of FIG. 5, the potential of the developing roller 245 is set to be higher than that of the photoreceptor drum 21. Thus, a developing bias occurs between the photoreceptor drum 21 and the developing roller 245, and a toner image is formed. Therefore, depending on the potential difference between the photoreceptor drum 21 and the developing roller 245, in-device contamination and BCO may occur.

In the case of the fourth image forming condition, charging is performed, but exposure to light is not performed. Therefore, as illustrated in column (D) of FIG. 5, the potential of the developing roller 245 is set to be higher than the charge potential VH of the photoreceptor drum 21. Thus, a developing bias occurs between the photoreceptor drum 21 and the developing roller 245, and a toner image is formed. Also in this case, depending on the potential difference between the photoreceptor drum 21 and the developing roller 245, in-device contamination and BCO may occur.

In the case of each of the first to third image forming conditions, charging and exposure to light are performed as described above. Therefore, in the case of each of the first to third image forming conditions, the potential of the developing roller 245 is not higher than the charge potential VH of the photoreceptor drum 21. Toner particles and carrier beads in the developing device 24 are adhered onto the developing roller 245. Therefore, compared with the case in which the fifth image forming condition or the fourth image forming condition is used to perform an image forming operation, possibility of occurrence of the secondary fault is low.

### The Execution Order of Image Forming Operations in Diagnostic Mode

In diagnostic mode according to the present exemplary embodiment, image forming operations are performed in the order starting from the fifth image forming condition to the first image forming condition.

Therefore, an operation of forming a toner image with execution, to the photoreceptor drum 21, of both charging and exposure to light is performed later than an operation of forming a toner image without execution, to the photoreceptor drum 21, of charging nor exposure to light. In addition, an operation of forming a toner image with execution, to the photoreceptor drum 21, of both charging and exposure to light is performed later than an operation of forming a toner image with execution, to the photoreceptor drum 21, of charging but not exposure to light. In addition, an operation of forming a toner image with execution, to the photoreceptor drum 21, of charging but not exposure to light is performed later than an operation of forming a toner image without execution, to the photoreceptor drum 21, of charging nor exposure to light.

In operations in diagnostic mode, after operations of forming toner images with execution, to the photoreceptor drum 21, of charging and exposure to light are performed under conditions different from normal mode, an operation of forming a toner image with execution, to the photoreceptor drum 21, of charging and exposure to light under the same condition as normal mode is performed last. In operations in diagnostic mode, operations of forming toner images with execution, to the photoreceptor drum 21, of charging and exposure to light under conditions different from normal mode are performed after an operation of forming a toner image without execution, to the photoreceptor drum 21, of charging or exposure to light and before an operation under the same condition as normal mode.

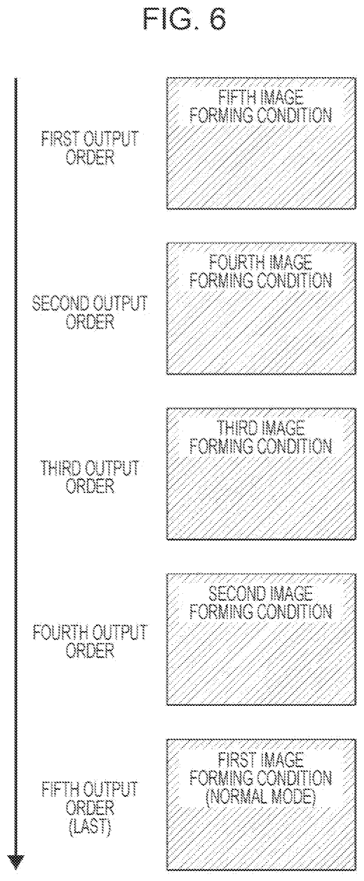

FIG. 6 is a diagram illustrating the output order of sheets P.

As illustrated in FIG. 6, image forming operations are formed in the order starting from the fifth image forming condition. Thus, in the output order, a diagnostic image formed through an image forming operation under the fifth image forming condition is output onto a sheet P first. After that, image forming operations under the respective image forming conditions are performed in the order, and the respective diagnostic images are output onto sheets P. Lastly, a diagnostic image formed through an image forming operation under the first image forming condition is output onto a sheet P. Thus, in the series of image forming operations in diagnostic mode, an image forming operation under the first image forming condition which is substantially the same as the normal image forming condition is performed last. Thus, even when in-device contamination occurs in operations performed under the special image forming conditions before, tonner causing in-device contamination may be deposited on a sheet P.

### Detection of an Image Defect

An image defect which appears in a diagnostic image in diagnostic mode will be described. Examples of an image defect include a streak appearing in a diagnostic image. For example, a streak appears as a single line in the sheet feed direction of a sheet P. A streak encompasses a colorless white streak and a color streak. When a streak appears in a diagnostic image, a malfunction has occurred in the image forming apparatus 2. In the present exemplary embodiment, a malfunction in the image forming apparatus 2 is identified on the basis of such an image defect.

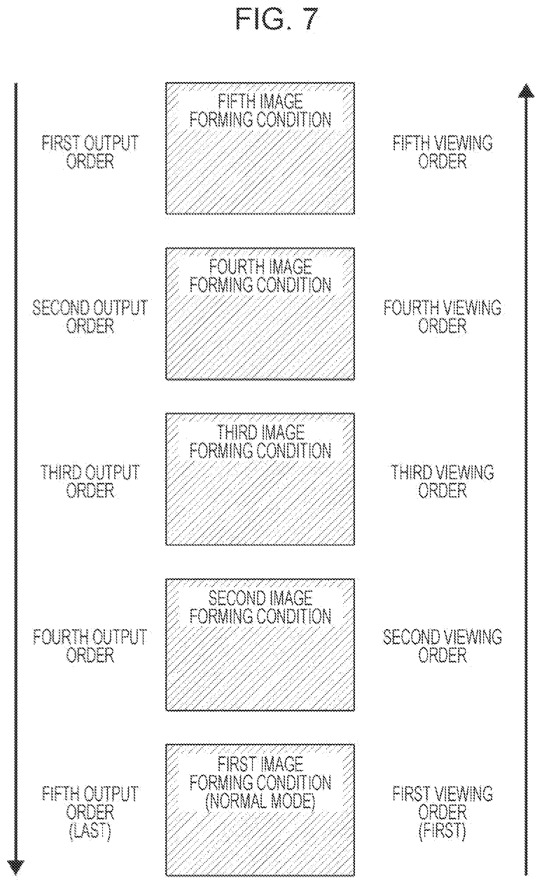

FIG. 7 is a diagram illustrating the order in which sheets P are to be viewed.

As illustrated in FIG. 7, image forming operations are performed in the order starting from the fifth image forming condition. Thus, in the output order, a diagnostic image formed through an image forming operation under the fifth image forming condition is output onto a sheet P first. After that, image forming operations under the respective image forming conditions are performed sequentially, and the respective diagnostic images are output onto sheets P. Lastly, a diagnostic image formed through an image forming operation under the first image forming condition is output onto a sheet P. Therefore, checking the topmost sheet P of the output stack of sheets P by an operator means that the operator views the last output sheet P, that is, the diagnostic image which is output under the normal image forming condition.

If a streak appears in the diagnostic image which is output under the normal image forming condition, the cause of the streak is determined to be based on a malfunction in the image forming unit 20. By using, as a reference, the state of the diagnostic image which is output under the normal image forming condition, the diagnostic images, which are output under the other image forming conditions, may be checked. The state of a diagnostic image refers to, for example, the state of whether a streak is present in the diagnostic image and the state of the location of the streak. Comparison among the states of diagnostic images, which are output under the respective image forming conditions, enables the fault location to be specified. The fault location may be specified by using the information processing apparatus 3.

The Configuration of the Information Processing Apparatus 3

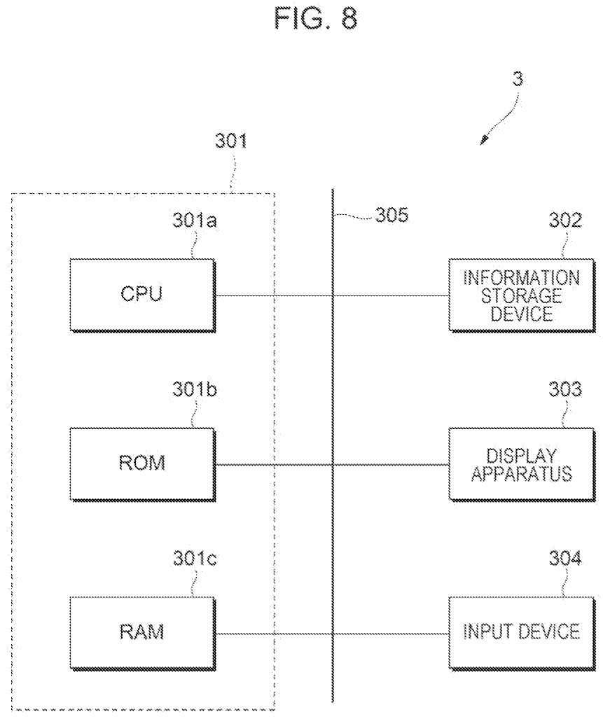

FIG. 8 is a diagram illustrating an exemplary configuration of the information processing apparatus 3.

The information processing apparatus 3 includes a computation processor 301, an information storage device 302 which stores information, a display apparatus 303, and an input device 304. The information processing apparatus 3 also includes a communication interface (not illustrated). The computation processor 301 is formed by a computer. The computation processor 301 includes a CPU 301a which is an exemplary processor performing various processes described below. The computation processor 301 also includes a ROM 301b storing programs, and a RAM 301c used as a work area. The information storage device 302 is implemented by using an existing device, such as a hard disk drive or a semiconductor memory. The computation processor 301, the information storage device 302, the display apparatus 303, and the input device 304 are connected to each other through a bus 305 or a signal line (not illustrated).

In the embodiment above, the term “processor” is broad enough to encompass one processor or plural processors in collaboration which are located physically apart from each other but may work cooperatively. The order of operations of the processor is not limited to one described in the embodiments above, and may be changed.

The display apparatus 303 displays information to users. Examples of the display apparatus 303 include a display. The input device 304 receives input from users. Examples of the input device 304 include a keyboard and a mouse, and a touch sensor. The input device 304 may be constituted by a touch panel in which a touch sensor is combined with a display. The communication interface is used in information communication with the image forming apparatus 2.

In the present exemplary embodiment, the information processing apparatus 3 diagnoses the state of the image forming apparatus 2 on the basis of diagnostic images formed on sheets P. This operation is performed in such a manner that the CPU 301a, which is an exemplary processor, reads programs, which are stored in the information storage device 302 or the like, onto the RAM 301c, which is used as a work area, for execution.

Specifically, for example, an operator uses the image reading apparatus 100, which is disposed on the image forming apparatus 2, to read sheets P in the reverse order of output of sheets P. Then, the image forming apparatus 2 uses the communication interface between the image forming apparatus 2 and the information processing apparatus 3 to transmit, to the information processing apparatus 3, information about the read sheets P. Then, the display apparatus 303 displays the diagnostic images in the order in which the sheets P are read by the image reading apparatus 100. The operator uses the input device 304 to input evaluations of the diagnostic images displayed on the display apparatus 303. The CPU 301a of the information processing apparatus 3 diagnoses the state of the image forming apparatus 2 on the basis of the evaluations which are input by the operator, and displays the result on the display apparatus 303.

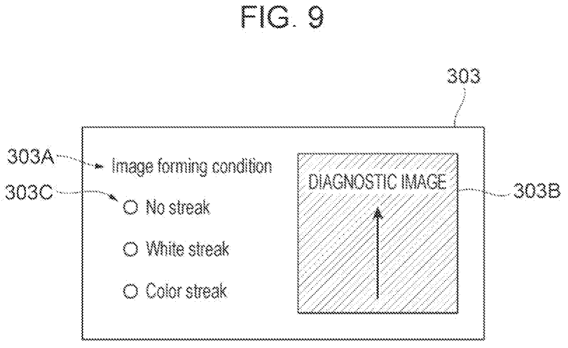

FIG. 9 is a diagram illustrating an exemplary evaluation input screen.

FIG. 9 illustrates a display field 303A, which indicates which image forming condition is used, a display field 303B, in which a diagnostic image is displayed, and a display field 303C, in which options for an operator to input the evaluation of the diagnostic image are displayed. In the display field 303A in FIG. 9, an image forming condition is displayed; in the display field 303B, a diagnostic image is displayed; in the display field 303C, the options for receiving input of an evaluation from an operator are displayed. While viewing a diagnostic image for each image forming condition, an operator inputs the evaluation of the diagnostic image. The arrow illustrated on the diagnostic image indicates the sheet feed direction.

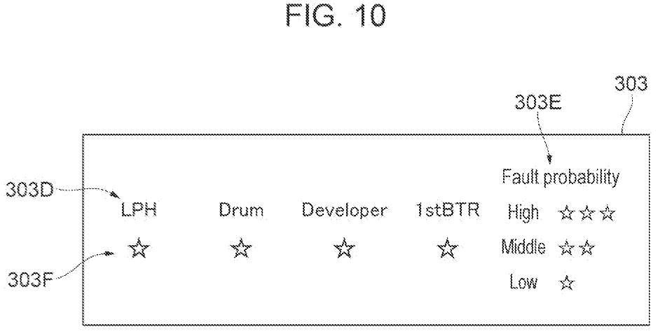

FIG. 10 is a diagram illustrating an exemplary diagnostic result screen.

In FIG. 10, a screen illustrating a diagnostic result is displayed. More specifically, the diagnostic result screen includes a display field 303D, in which components of the image forming unit 20 are displayed, a display field 303E, which illustrates fault probability, and a display field 303F, in which a diagnostic result is displayed. In the display field 303D, “LPH”, “Drum”, “Developer”, and “1stBTR” are displayed. “LPH” indicates the exposure device 23. “Drum” indicates the photoreceptor drum 21 and the charging device 22. “Developer” indicates the developing device 24. “1stBTR” indicates the first transfer roller 25. In the display field 303E, fault probability is illustrated. In this example, “High”, “Middle”, and “Low” are illustrated in the descending order of fault probability, and are each represented by the number of stars which indicates the corresponding fault probability. In the display field 303F, a diagnostic result obtained by the CPU 301a is displayed. In FIG. 10, for example, one star is displayed for “LPH”. From this, it is recognized that the exposure device 23 has a low fault probability. An operator views the diagnostic result to grasp the fault location.

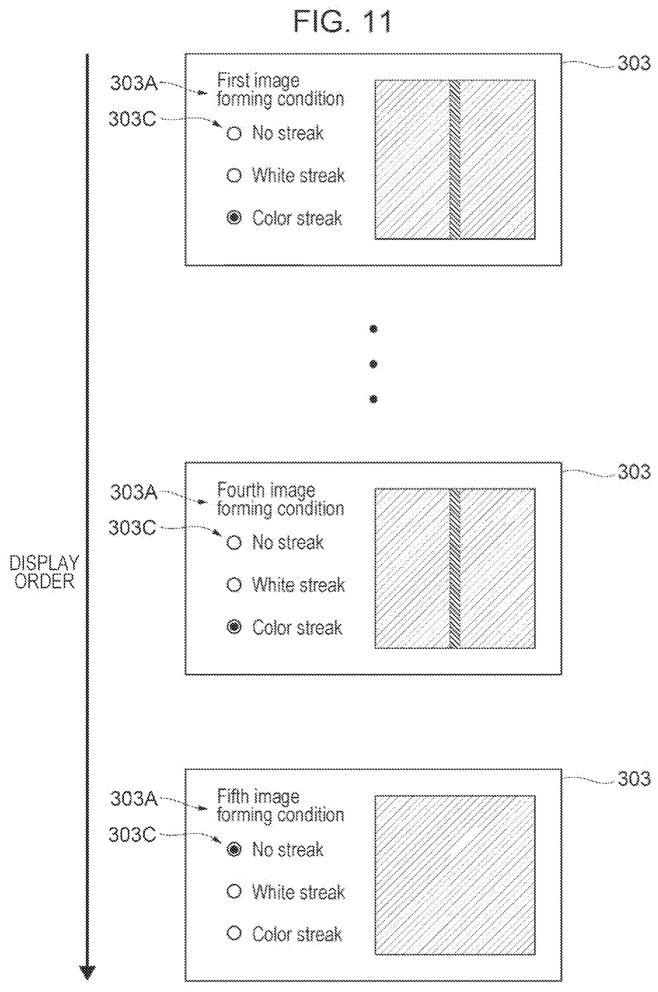

FIG. 11 is a diagram illustrating an example in which the image forming apparatus 2 is diagnosed.

Herein, diagnosis of the image forming apparatus 2 through use of the information processing apparatus 3 will be described by taking, as an example, the case in which a color streak appears in the diagnostic images in image forming operations performed under the first to fourth image forming conditions, and in which the streak disappears in the diagnostic image in an image forming operation under the fifth image forming condition. This is merely an example.

An operator uses the image reading apparatus 100, which is included in the image forming apparatus 2, to read sheets P in the reverse order of output of the sheets P. That is, the sheets P are read in the order starting from the sheet P which is output under the first image forming condition. As described above, the first image forming condition is the normal image forming condition. Then, the image forming apparatus 2 uses the communication interface between the image forming apparatus 2 and the information processing apparatus 3 to transmit, to the information processing apparatus 3, information about the read sheets P. Then, the CPU 301a of the information processing apparatus 3 causes the display apparatus 303 to display the diagnostic images in the order in which the image reading apparatus 100 have read the sheets P. That is, the diagnostic images, which are formed under the image forming conditions, are displayed in the order starting from the first image forming condition. As illustrated in FIG. 11, the diagnostic image, which is obtained under the first image forming condition, and the options for inputting the state of the diagnostic image are displayed first on the display apparatus 303. As illustrated in FIG. 11, a color streak appears in the diagnostic image. The operator uses the input device 304 to select the color streak option. In the present exemplary embodiment, as described above, a color streak appears in the diagnostic images obtained under the first to fourth image forming conditions. Therefore, the color streak options are selected for the first to forth image forming conditions. The color streak disappears in the diagnostic image obtained under the fifth image forming condition. Therefore, the operator selects the no-streak option by using the input device 304. On the basis of the input of the evaluations, the CPU 301a performs diagnosis and specifies the fault location.

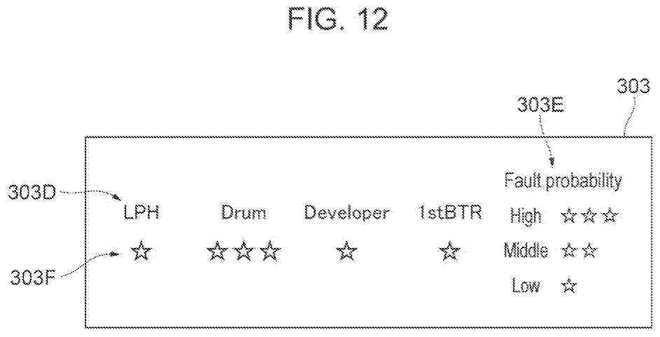

FIG. 12 is a diagram illustrating a diagnostic result of the image forming apparatus 2.

In the example described above, a color streak appears under the fourth image forming condition of performing charging but not exposure to light; the color streak disappears under the fifth image forming condition of performing neither charging nor exposure to light. Thus, the CPU 301a of the information processing apparatus 3 determines that the color streak is highly likely to occur due to the charging device 22. Therefore, as illustrated in FIG. 12, in the screen illustrating the diagnostic result, three stars are displayed for “Drum”. Thus, the operator identifies the charging device 22 as the fault location in the image forming apparatus 2.

In the description above, the image reading apparatus 100 included in the image forming apparatus 2 is used to read images. However, the configuration is not limited to this. An image reading apparatus other than the image forming apparatus 2 may be provided. In this case, the information processing apparatus 3 uses a communication interface to obtain, from the image reading apparatus, information about read images.

An image forming unit 20, which is a diagnostic target, may be diagnosed through an operator's viewing. In the present exemplary embodiment, the order in which image forming operations under the image forming conditions are performed is predetermined. Thus, if the output diagnostic images are viewed sequentially, the operator may identify which diagnostic image is obtained under which image forming condition. Thus, the operator may diagnose an image forming unit 20 which is a diagnostic target.

An exemplary embodiment of the present disclosure is described above. However, the technical scope of the present disclosure is not limited the exemplary embodiment. For example, in the present exemplary embodiment, the five image forming conditions are used to output diagnostic images onto sheets P. However, the configuration is not limited to this. When an image forming unit 20 is diagnosed, the image forming conditions to be used may be changed as long as the first, fourth, and fifth image forming conditions are included. Even when the image forming conditions to be used are changed, the first image forming condition, that is, the normal image forming condition, is used to perform the last image forming operation. Thus, even if in-device contamination occurs, the in-device contamination may be deposited on a sheet P. Thus, occurrence of in-device contamination may be determined by checking the output sheet P.

The present exemplary embodiment employs the form in which, on the display apparatus 303, a diagnostic image, which is formed under the first image forming condition, is displayed first, and in which diagnostic images are then displayed sequentially until the fifth image forming condition. These diagnostic images may be displayed at a time. In the display field 303A on the display apparatus 303, information about which image forming condition is used is displayed. Thus, an operator may view the information to identify which diagnostic image is obtained under which image forming condition. Other than these, various changes and alternative configurations, which do not depart from the scope of the technical idea of the present disclosure, are encompassed in the present disclosure.

### Appendix

(((1)))

An image forming apparatus comprising:

an image forming unit that transfers a toner image onto a recording medium, the toner image being formed on an image carrier by an electrophotographic system; and

one or more processors that control an operation of the image forming unit, and that are configured to:
when causing the image forming unit to perform a plurality of operations under different conditions of charging and exposure to light, cause the image forming unit to perform later an operation with charging and exposure to light, the plurality of operations including at least the operation with charging and exposure to light and an operation without charging nor exposure to light, the operation with charging and exposure to light being an operation in which a toner image is formed with the image carrier having been subjected to charging and exposure to light, the operation without charging nor exposure to light being an operation in which a toner image is formed with the image carrier having been subjected to neither charging nor exposure to light.
(((2)))

The image forming apparatus according to (((1))),

wherein the one or more processors are configured to:
when the plurality of operations performed by the image forming unit include the operation with charging and exposure to light and an operation with charging but not exposure to light, cause the operation with charging and exposure to light to be performed later, the operation with charging and exposure to light being an operation in which a toner image is formed with the image carrier having been subjected to charging and exposure to light, the operation with charging but not exposure to light being an operation in which a toner image is formed with the image carrier having been subjected to charging but not to exposure to light.
(((3)))

The image forming apparatus according to (((1))) or (((2))),

wherein the one or more processors are configured to:
when the plurality of operations include the operation without charging nor exposure to light and the operation with charging but not exposure to light, cause the operation with charging but not exposure to light to be performed later, the plurality of operations being operations that the one or more processors cause the image forming unit to perform, the operation without charging nor exposure to light being an operation in which a toner image is formed with the image carrier having been subjected to neither charging nor exposure to light, the operation with charging but not exposure to light being an operation in which a toner image is formed with the image carrier having been subjected to charging but not to exposure to light.
(((4)))

The image forming apparatus according to any of (((1))) to (((3))),

wherein the image forming unit is capable of performing an operation of forming a toner image in normal mode and diagnostic mode, the normal mode indicating normal image output, the diagnostic mode being a mode for diagnosing the image forming unit, and

wherein the one or more processors are configured to:
in an operation in the diagnostic mode, cause an operation of forming a toner image to be performed with the image carrier having been processed under a different condition about charging and exposure to light, the different condition being different from the normal mode, and cause an operation of forming a toner image to be performed last with the image carrier having been processed under an identical condition about charging and exposure to light, the identical condition being identical to the normal mode.
(((5)))

The image forming apparatus according to (((4))),

wherein the one or more processors are configured to:
in the operation in the diagnostic mode, form a toner image with the image carrier having been subjected to charging and exposure to light under a condition different from an operation in the normal mode, after execution of an operation of forming a toner image with the image carrier having been subjected to either charging or exposure to light, before execution of an operation under the condition identical to an operation in the normal mode.
(((6)))

A processing system comprising:

the image forming apparatus according to any of (((1))) to (((5)));

a reading apparatus that reads the recording medium on which a toner image has been formed by the image forming apparatus;

a display apparatus that displays an image formed on the recording medium, the image being read by the reading apparatus;

a receiving apparatus that receives input of an evaluation result of the image displayed by the display apparatus; and

a diagnostic apparatus that diagnoses a state of the image forming apparatus on a basis of the evaluation result received by the receiving apparatus.
(((7)))

The processing system according to (((6))),

wherein the reading apparatus reads pieces of the recording medium in reverse order of output from the image forming apparatus, and

wherein the display apparatus displays images on the pieces of the recording medium in order of reading by the reading apparatus.
(((8)))

A program for controlling a computer included in an image forming apparatus, the image forming apparatus including an image forming unit, the image forming unit transferring a toner image onto a recording medium, the toner image being formed on an image carrier by an electrophotographic system, the image forming unit having a function of forming a toner image without charging nor exposure to light, the computer controlling an operation of the image forming apparatus, the program causing the computer to execute a process comprising:

when the image forming unit is caused to perform a plurality of operations under different conditions of charging and exposure to light to the image carrier,

causing the image forming unit to perform a process of forming a toner image with the image carrier having been subjected to neither charging nor exposure to light; and,

after that, causing the image forming unit to perform a process of forming a toner image with the image carrier having been subjected to charging and exposure to light.

What is claimed is:

1. An image forming apparatus comprising:
an image forming unit that transfers a toner image onto a recording medium, the toner image being formed on an image carrier by an electrophotographic system; and
one or more processors that control an operation of the image forming unit, and that are configured to:
when causing the image forming unit to perform a plurality of operations under different conditions of charging and exposure to light, cause the image forming unit to perform later an operation with charging and exposure to light, the plurality of operations including at least the operation with charging and exposure to light and an operation without charging nor exposure to light, the operation with charging and exposure to light being an operation in which a toner image is formed with the image carrier having been subjected to charging and exposure to light, the operation without charging nor exposure to light being an operation in which a toner image is formed with the image carrier having been subjected to neither charging nor exposure to light.

2. The image forming apparatus according to claim 1,
wherein the one or more processors are configured to:
when the plurality of operations performed by the image forming unit include the operation with charging and exposure to light and an operation with charging but not exposure to light, cause the operation with charging and exposure to light to be performed later, the operation with charging and exposure to light being an operation in which a toner image is formed with the image carrier having been subjected to charging and exposure to light, the operation with charging but not exposure to light being an operation in which a toner image is formed with the image carrier having been subjected to charging but not to exposure to light.

3. The image forming apparatus according to claim 2,
wherein the one or more processors are configured to:
when the plurality of operations include the operation without charging nor exposure to light and the operation with charging but not exposure to light, cause the operation with charging but not exposure to light to be performed later, the plurality of operations being operations that the one or more processors cause the image forming unit to perform, the operation without charging nor exposure to light being an operation in which a toner image is formed with the image carrier having been subjected to neither charging nor exposure to light, the operation with charging but not exposure to light being an operation in which a toner image is formed with the image carrier having been subjected to charging but not to exposure to light.

4. The image forming apparatus according to claim 1,
wherein the image forming unit is capable of performing an operation of forming a toner image in normal mode and diagnostic mode, the normal mode indicating normal image output, the diagnostic mode being a mode for diagnosing the image forming unit, and
wherein the one or more processors are configured to:
in an operation in the diagnostic mode, cause an operation of forming a toner image to be performed with the image carrier having been processed under a different condition about charging and exposure to light, the different condition being different from the normal mode, and cause an operation of forming a toner image to be performed last with the image carrier having been processed under an identical condition about charging and exposure to light, the identical condition being identical to the normal mode.

5. The image forming apparatus according to claim 4,
wherein the one or more processors are configured to:
in the operation in the diagnostic mode, form a toner image with the image carrier having been subjected to charging and exposure to light under a condition different from an operation in the normal mode, after execution of an operation of forming a toner image with the image carrier having been subjected to either charging or exposure to light, before execution of an operation under the condition identical to an operation in the normal mode.

6. A processing system comprising:
the image forming apparatus according to claim 1;
a reading apparatus that reads the recording medium on which a toner image has been formed by the image forming apparatus;
a display apparatus that displays an image formed on the recording medium, the image being read by the reading apparatus;
a receiving apparatus that receives input of an evaluation result of the image displayed by the display apparatus; and
a diagnostic apparatus that diagnoses a state of the image forming apparatus on a basis of the evaluation result received by the receiving apparatus.

7. A processing system comprising:
the image forming apparatus according to claim 2;
a reading apparatus that reads the recording medium on which a toner image has been formed by the image forming apparatus;
a display apparatus that displays an image formed on the recording medium, the image being read by the reading apparatus;
a receiving apparatus that receives input of an evaluation result of the image displayed by the display apparatus; and
a diagnostic apparatus that diagnoses a state of the image forming apparatus on a basis of the evaluation result received by the receiving apparatus.

8. A processing system comprising:
the image forming apparatus according to claim 3;
a reading apparatus that reads the recording medium on which a toner image has been formed by the image forming apparatus;
a display apparatus that displays an image formed on the recording medium, the image being read by the reading apparatus;
a receiving apparatus that receives input of an evaluation result of the image displayed by the display apparatus; and
a diagnostic apparatus that diagnoses a state of the image forming apparatus on a basis of the evaluation result received by the receiving apparatus.

9. A processing system comprising:
the image forming apparatus according to claim 4;
a reading apparatus that reads the recording medium on which a toner image has been formed by the image forming apparatus;
a display apparatus that displays an image formed on the recording medium, the image being read by the reading apparatus;
a receiving apparatus that receives input of an evaluation result of the image displayed by the display apparatus; and
a diagnostic apparatus that diagnoses a state of the image forming apparatus on a basis of the evaluation result received by the receiving apparatus.

10. A processing system comprising:
the image forming apparatus according to claim 5;
a reading apparatus that reads the recording medium on which a toner image has been formed by the image forming apparatus;
a display apparatus that displays an image formed on the recording medium, the image being read by the reading apparatus;
a receiving apparatus that receives input of an evaluation result of the image displayed by the display apparatus; and
a diagnostic apparatus that diagnoses a state of the image forming apparatus on a basis of the evaluation result received by the receiving apparatus.

11. The processing system according to claim 6,
wherein the reading apparatus reads pieces of the recording medium in reverse order of output from the image forming apparatus, and
wherein the display apparatus displays images on the pieces of the recording medium in order of reading by the reading apparatus.

12. The processing system according to claim 7,
wherein the reading apparatus reads pieces of the recording medium in reverse order of output from the image forming apparatus, and
wherein the display apparatus displays images on the pieces of the recording medium in order of reading by the reading apparatus.

13. The processing system according to claim 8,
wherein the reading apparatus reads pieces of the recording medium in reverse order of output from the image forming apparatus, and
wherein the display apparatus displays images on the pieces of the recording medium in order of reading by the reading apparatus.

14. The processing system according to claim 9,
wherein the reading apparatus reads pieces of the recording medium in reverse order of output from the image forming apparatus, and
wherein the display apparatus displays images on the pieces of the recording medium in order of reading by the reading apparatus.

15. The processing system according to claim 10,
wherein the reading apparatus reads pieces of the recording medium in reverse order of output from the image forming apparatus, and
wherein the display apparatus displays images on the pieces of the recording medium in order of reading by the reading apparatus.

16. A non-transitory computer readable medium storing a program for controlling a computer included in an image forming apparatus, the image forming apparatus including an image forming unit, the image forming unit transferring a toner image onto a recording medium, the toner image being formed on an image carrier by an electrophotographic system, the image forming unit having a function of forming a toner image without charging nor exposure to light, the computer controlling an operation of the image forming apparatus, the program causing the computer to execute a process comprising:
when the image forming unit is caused to perform a plurality of operations under different conditions of charging and exposure to light to the image carrier,
causing the image forming unit to perform a process of forming a toner image with the image carrier having been subjected to neither charging nor exposure to light; and,
after that, causing the image forming unit to perform a process of forming a toner image with the image carrier having been subjected to charging and exposure to light.

17. A method for an image forming apparatus including an image forming unit, the image forming unit transferring a toner image onto a recording medium, the toner image being formed on an image carrier by an electrophotographic system, the image forming unit having a function of forming a toner image without charging nor exposure to light, the method comprising:
when the image forming unit is caused to perform a plurality of operations under different conditions of charging and exposure to light to the image carrier,
causing the image forming unit to perform a process of forming a toner image with the image carrier having been subjected to neither charging nor exposure to light; and,
after that, causing the image forming unit to perform a process of forming a toner image with the image carrier having been subjected to charging and exposure to light.
